(19) United States
(12) Patent Application Publication
(10) Pub. No.: US 2010/0315241 A1
(43) Pub. Date: Dec. 16, 2010

(54) PET POSITIONING DEVICE, PET MONITORING DEVICE AND PET TRACKING SYSTEM THEREOF

(76) Inventor: En-Min JOW, Hsinchu (TW)

Correspondence Address: Muncy, Geissler, Olds & Lowe, PLLC, 4000 Legato Road, Suite 310, FAIRFAX, VA, 22033, US

(21) Appl. No.: 12/552,005

(22) Filed: Sep. 1, 2009

(30) Foreign Application Priority Data
Jun. 11, 2009 (TW) 98119498

(51) Int. Cl. G08B 23/00; A01K 29/00

(52) U.S. Cl. 340/573.3; 119/174

(57) ABSTRACT

A pet tracking system includes a pet positioning device and a pet monitoring device. The pet positioning device is worn on a pet and includes a positioning unit which is configured for detecting a position of the pet. And, the pet positioning device builds a direct wireless communication to the pet monitoring device by a wireless communication unit to send back the position of the pet. Therefore, the pet monitoring device is able to acquire the position of the pet without a mobile communication provided by a telecommunication proprietor. In preferred embodiment, the pet monitoring device can provide a warning signal to remind pet owners to pay attention to the pet while the pet is out of a predetermined range.

### BACKGROUND OF THE INVENTION

1. Field of the Invention

The present invention is related to a positioning device, monitoring device and tracking system thereof, and more particularly to a pet positioning device, pet monitoring device and pet tracking system thereof that avoid pets from missing.

2. Description of the Prior Art

In recent years, people are too busy at work to take sufficient recreation after work, so that pet raising becomes a way of reducing loneliness for most people. For example, people at work who have no child treat their pets so well like their own children. Besides, raising pets also possesses meaning of education for children; and pets are good companies for people who have melancholia.

Accordingly, no matter what reasons for raising pets, a pet plays important role for its owner. In other words, it would become a tremendous trauma for the pet owner if their pets get lost, especially for pets which are noble or rare breed. Therefore, it is necessary to have an appropriate tracking device to avoid pets from being stolen or getting lost. The conventional tracking device functions by integrating a positioning module and a mobile communication module, such as GSM and GPRS etc. The tracking device is worn on the pet and the coordinate outputted by the positioning module is transmitted to the pet owner via the mobile communication module, so that the pet owner may be informed with the position of the pet. However, utilizing the mobile communication module would be charged by a telecommunication proprietor and the cost becomes an extra burden for pet owner to raise pets.

To sum up the foregoing descriptions, how to develop a system to track the position of a pet without paying any additional communication fee is an important goal to be achieved.

### SUMMARY OF THE INVENTION

The present invention is directed to provide a pet positioning device, pet monitoring device and pet tracking system thereof, which may transmit a positioning information to let the pet owner be aware of the position of the pet without accessing a mobile communication network provided by telecommunication proprietor. In a preferred embodiment, the pet monitoring device provides a warning signal to the pet owner, when the distance between the pet and the pet owner exceeds a predetermined range.

According to an embodiment, a pet tracking system comprises: a pet positioning device and a pet monitoring device. The pet positioning device is worn on a pet and comprises: a first positioning unit, a first wireless communication unit, a first controller and a first power supply unit. The first positioning unit is configured for detecting a position of the pet positioning device and outputting a positioning information. The first wireless communication unit is configured for transmitting a wireless signal periodically. The first controller is electrically connected with the first positioning unit and the first wireless communication unit for receiving a positioning information and integrating the positioning information with the wireless signal. The first power supply unit is configured for powering the pet positioning device.

The pet monitoring device comprises: a second wireless communication unit, a second controller, a prompting unit and a second power supply unit. The second wireless communication unit is configured for receiving the wireless signal transmitted by the pet positioning device. The second controller is electrically connected with the second wireless communication unit for retrieving the positioning information from the wireless signal. The prompting unit is electrically connected with the second controller for outputting the positioning information in a user recognizable format. The second power supply unit is configured for powering the pet monitoring device.

According to another embodiment of the present invention, a pet positioning device worn on a pet is provide and combined with a pet monitoring device to form a pet tracking system. The pet positioning device comprises a first positioning unit, a first wireless communication unit, a first controller and a first power supply unit. The first positioning unit is configured for detecting a position of the pet positioning device and outputting a positioning information. The first wireless communication unit is configured for transmitting a wireless signal periodically. The first controller is electrically connected with the first positioning unit and the first wireless communication unit for receiving the positioning information and integrating the positioning information with the wireless signal. The first power supply unit is configured for powering the pet positioning device.

According to another embodiment of the present invention, a pet monitoring device is provided and combined with a pet positioning device to form a pet tracking system. The pet monitoring device comprises: a second wireless communication unit, a second controller, a prompting unit and a second power supply unit. The second wireless communication unit is configured for receiving the wireless signal transmitted by the pet positioning device. The second controller is electrically connected with the second wireless communication unit for retrieving the positioning information from the wireless signal. The prompting unit is electrically connected with the second controller for outputting the positioning information in a user recognizable format. The second power supply unit is configured for powering the pet monitoring device.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram schematically illustrating a pet positioning device, pet monitoring device and pet tracking system thereof according to an embodiment of the present invention; and

FIG. 2 is block diagram schematically illustrating a pet positioning device, pet monitoring device and pet tracking system thereof according to another embodiment of the present invention.

### DESCRIPTION OF THE PREFERRED EMBODIMENT

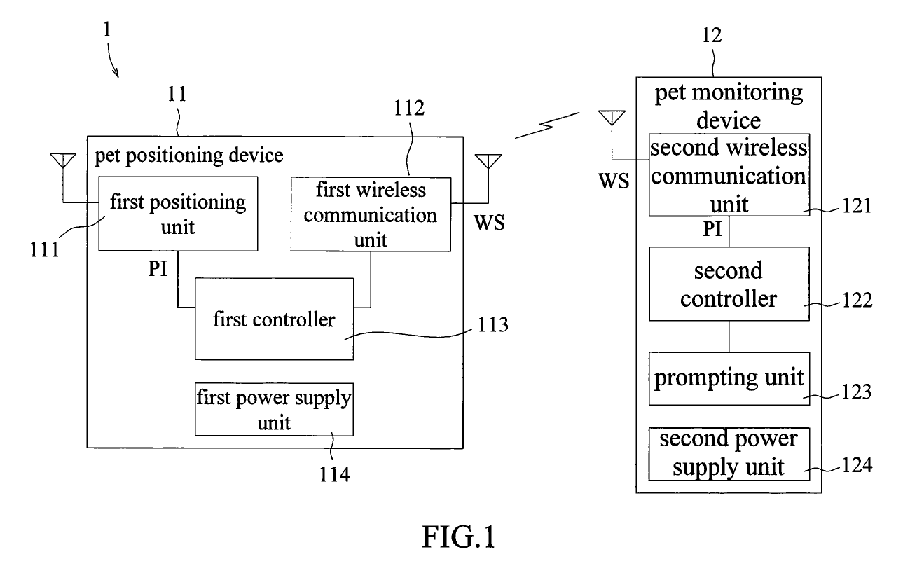

Referring to FIG. 1, a pet tracking system 1 according to an embodiment of the present invention comprises a pet positioning device 11 and a pet monitoring device 12. The pet positioning device 11 is worn on a pet and comprises a first positioning unit 111, a first wireless communication unit 112, a first controller 113 and a first power supply unit 114. The first positioning unit 111 is configured for detecting a position of the pet positioning device 11 and outputting a positioning information PI. For example, the first positioning unit 111 comprises a global positioning system (GPS). The first wireless communication unit 112 is configured for transmitting a wireless signal WS periodically. The first controller 113 is electrically connected with the first positioning unit 11 and the first wireless communication unit 112 and configured for receiving the positioning information PI outputted by the first positioning unit 111 and integrating the positioning information PI with the wireless signal WS and transmitting the wireless signal WS. The first power supply unit 114 is configured for supplying power to the pet positioning device 11.

The pet monitoring device 12 comprises a second wireless communication unit 121, a second controller 122, a prompting unit 123 and a second power supply unit 124. The second wireless communication unit 121 is configured for receiving the wireless signal WS transmitted by the pet positioning device 11. The second controller 122 is electrically connected with the second wireless communication unit 121 and configured for retrieving the positioning information PI from the wireless signal WS. The prompting unit 123 is electrically connected with the second controller 122 for outputting the positioning information PI outputted by the second controller 122 in a user recognizable format. In one embodiment according to the present invention, the prompting unit 123 comprises a display unit and/or a sound generating unit, such as a speaker, so that the positioning information PI may be displayed on the display unit or outputted as a sound to remind user. The second power supply unit 124 is configured for supplying power to the pet monitoring device 12.

According to the aforementioned structure, the pet monitoring device 12 may estimate the distance between the pet positioning device 11 and the pet monitoring device 12 according to the wireless signal WS transmitted by the pet positioning device 11. In one embodiment, when the distance between the pet positioning device 11 and the pet monitoring device 12 is larger than a predetermined distance, the second controller 122 of the pet monitoring device 12 generates a control signal and the pet monitoring device 12 communicates with the pet positioning device 11 via the second wireless communication unit 121 to enable the first positioning unit 111 of the pet positioning device 11 to output the corresponding positioning information PI, or to alter a period that the first positioning unit 111 outputs the positioning information PI.

For example, when the pet moves within the predetermined range, the first positioning unit 111 of the pet positioning device 11 outputs no corresponding positioning information PI (i.e. the first positioning unit 111 is switched off) or outputs the positioning information PI with a longer interval, e.g. outputting the positioning information PI per 10 minutes, alternatively. When the pet exceeds the predetermined range, the first positioning unit 111 is switched on and outputs the corresponding positioning information PI or outputs the corresponding positioning information PI in a shortened period, e.g. outputting the positioning information PI per 1 minute. In preferred embodiment, the second controller 122 of the pet monitoring device 12 may output a warning signal via the prompting unit 123 to remind the pet owner when the pet exceeds the predetermined range.

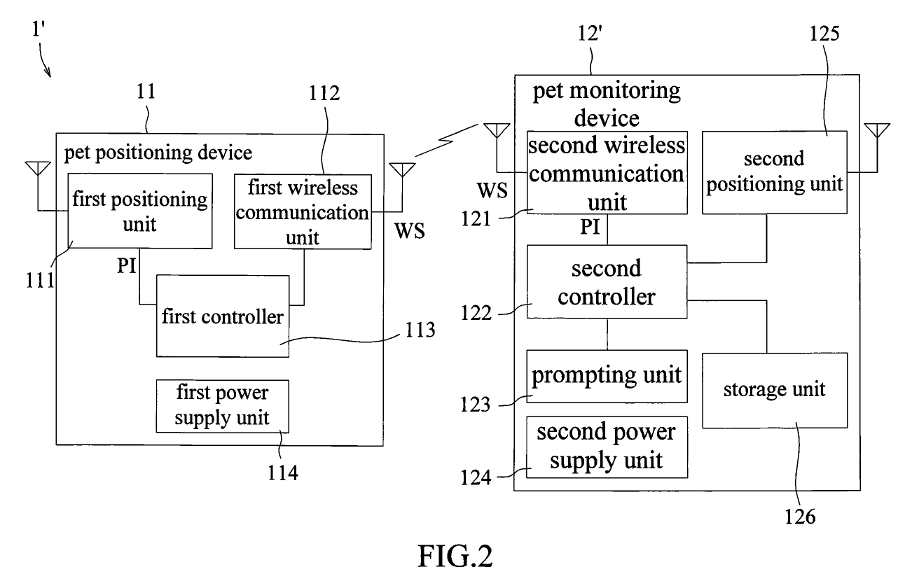

Referring to FIG. 2, a pet monitoring device 12′ of pet tracking system 1′ according to another embodiment of the present invention further comprises a storage unit 126 electrically connected with the second controller 122 and configured for storing the positioning information PI transmitted by the pet positioning device 11 and a corresponding time stamp. Accordingly, the pet monitoring device 12′ may be able to record moving trajectories of the pet, which is useful for finding the lost or stolen pet and get them back. In one embodiment, the storage unit 126 may also store a map information, so that the prompting unit 123 may display the positioning information PI and the map information at the same time for the pet owner to be more aware of the position of the pet.

Referring to FIG. 2 again, the pet monitoring device 12′ also comprises a second positioning unit 125 electrically connected with the second controller 122. The second positioning unit 125 is configured for detecting the position of the pet monitoring device 12′ so that the second controller 122 may provide a navigation information according to the position of the pet monitoring device 12′ and the positioning information PI transmitted by the pet positioning device 11. For example, the pet monitoring device 12′ may provide the distance and direction information about the pet positioning device 11 with respect to the pet monitoring 12′ by vocal signal. Alternatively, a navigation information is displayed on a display unit regarding the position of the pet positioning device 11 as a destination and the position of the pet monitoring device 12′ as a start. In one embodiment, the second positioning unit 125 may be a global positioning system (GPS), for example.

To sum up the foregoing descriptions, the pet positioning device and the pet monitoring device according to the present invention connects each other wirelessly to form a pet tracking system. Therefore, the tracking system may transmit the positioning information without accessing the mobile communication network provided by a telecommunication proprietor so that the pet owner may be aware of the position of their pets with lower cost. Besides, if a pet is lost or stolen, as long as the pet positioning device is within a communication range of the pet monitoring device, such as 100 meter or 1000 meter, the pet owner may be informed with the position of the pet and find it back efficiently. In preferred embodiment, when the pet leaves away from the pet owner for a predetermined distance, the pet tracking system according to the present invention may provide a warning signal to the pet owner to remind the pet owners about the position of their pets.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A pet tracking system comprising:
a pet positioning device worn on a pet and comprising:
a first positioning unit for detecting a position of said pet positioning device and outputting a positioning information;
a first wireless communication unit for transmitting a wireless signal periodically;
a first controller electrically connected with said first positioning unit and said first wireless communication unit and configured for receiving said positioning information and integrating said positioning information with said wireless signal; and
a first power supply unit for supplying power to said pet positioning device; and
a pet monitoring device comprising:
a second wireless communication unit for receiving said wireless signal transmitted by said pet positioning device;
a second controller electrically connected with said second wireless communication unit and configured for retrieving said positioning information from said wireless signal;
a prompting unit electrically connected with said second controller and configured for outputting said positioning information in a user recognizable format; and
a second power supply unit for supplying power to said pet monitoring device.

2. The pet tracking system according to claim 1, wherein said second controller generates a control signal and transmits said control signal via said second wireless communication unit to enable said first positioning unit or alter a period of said first positioning unit for outputting said positioning information when a distance between said pet positioning device and said pet monitoring device is larger than a predetermined distance.

3. The pet tracking system according to claim 1, wherein said second controller generates a warning signal and outputs said warning signal via said prompting unit when a distance between said pet positioning device and said pet monitoring device is larger than a predetermined distance.

4. The pet tracking system according to claim 1, wherein said pet monitoring device further comprises:
a storage unit electrically connected with said second controller and configured for storing said positioning information and a corresponding time stamp.

5. The pet tracking system according to claim 1, wherein said pet monitoring device further comprises:
a storage unit electrically connected with said second controller and configured for storing a map information, wherein said prompting unit displays said positioning information and said map information.

6. The pet tracking system according to claim 1, wherein said pet monitoring device further comprises:
a second positioning unit electrically connected with said second controller and configured for detecting a position of said pet monitoring device, wherein said second controller provides a navigation information based on said position of said pet monitoring device and said positioning information.

7. The pet tracking system according to claim 6, wherein said second positioning unit comprises a global positioning system (GPS).

8. The pet tracking system according to claim 1, wherein said first positioning unit comprises a global positioning system (GPS).

9. The pet tracking system according to claim 1, wherein said prompting unit comprises a display unit and/or a sound generating unit.

10. A pet positioning device, which is worn on a pet and is combined with a pet monitoring device to form a pet tracking system, wherein said pet monitoring device comprises a second wireless communication unit for receiving a wireless signal transmitted by said pet positioning device; a second controller electrically connected with said second wireless communication unit and configured for retrieving a positioning information from said wireless signal; a prompting unit electrically connected with said second controller and configured for outputting said positioning information in a user recognizable format; and a second power supply unit for supplying power to said pet monitoring device, comprising:
a first positioning unit for detecting a position of said pet positioning device and outputting said positioning information;
a first wireless communication unit for transmitting said wireless signal periodically;
a first controller electrically connected with said first positioning unit and said first wireless communication unit and configured for receiving said positioning information and integrating said positioning information with said wireless signal; and
a first power supply unit for supplying power to said pet positioning device.

11. The pet positioning device according to claim 10, wherein said first positioning unit is enabled or a period of said first positioning unit for outputting said positioning information is altered when a distance between said pet positioning device and said pet monitoring device is larger than a predetermined distance.

12. The pet positioning device according to claim 10, wherein said first positioning unit comprises a global positioning system (GPS).

13. The pet monitoring device, which is combined with a pet positioning device to form a pet tracking system, wherein said pet positioning device is worn on a pet and comprises a first positioning unit for detecting a position of said pet positioning device and outputting a positioning information; a first wireless communication unit for transmitting a wireless signal periodically; a first controller electrically connected with said first positioning unit and said first wireless communication unit and configured for receiving said positioning information and integrating said positioning information with said wireless signal; and a first power supply unit for supplying power to said pet positioning device, comprising:
a second wireless communication unit for receiving said wireless signal transmitted by said pet positioning device;
a second controller electrically connected with said second wireless communication unit and configured for retrieving said positioning information from said wireless signal;
a prompting unit electrically connected with said second controller and configured for outputting said positioning information in a user recognizable format; and
a second power supply unit for supplying power to said pet monitoring device.

14. The pet monitoring device according to claim 13, wherein said second controller generates a control signal and transmits said control signal via said second wireless communication unit to enable said first positioning unit or alter a period of said first positioning unit for outputting said positioning information when a distance between said pet positioning device and said pet monitoring device is larger than a predetermined distance.

15. The pet monitoring device according to claim 13, wherein said second controller generates a warning signal and outputs said warning signal via said prompting unit when a distance between said pet positioning device and said pet monitoring device is larger than a predetermined distance.

16. The pet monitoring device according to claim 13, further comprising:
a storage unit electrically connected with said second controller and configured for storing said positioning information and a corresponding time stamp.

17. The pet monitoring device according to claim 13, further comprising:
a storage unit electrically connected with said second controller and configured for storing a map information, wherein said prompting unit displays said positioning information and said map information.

18. The pet monitoring device according to claim 13, further comprising:
a second positioning unit electrically connected with said second controller and configured for detecting a position of said pet monitoring device, wherein said second controller provides a navigation information based on said position of said pet monitoring device and said positioning information.

19. The pet monitoring device according to claim 18, wherein said second positioning unit comprises a global positioning system (GPS).

20. The pet monitoring device according to claim 13, said prompting unit comprises a display unit and/or a sound generating unit.
